(19) United States
(12) Patent Application Publication
(10) Pub. No.: US 2010/0250777 A1
(43) Pub. Date: Sep. 30, 2010

(54) Methods, Systems, And Computer Program Products For Resolving A First Source Node Identifier To A Second Source Node Identifier

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/414,007

(22) Filed: Mar. 30, 2009

(51) Int. Cl. G06F 15/16

(52) U.S. Cl. 709/245

(57) ABSTRACT

Methods and systems are described for resolving a first source node identifier to a second source node identifier. In one aspect, a method includes receiving a first query for resolving a first target node identifier to a second target node identifier in association with receiving source node information identifying a first source node identifier and a second source node identifier. The method includes storing a record associating the first source node identifier with the second source node identifier. The method further includes receiving a second query for resolving the first source node identifier to the second source node identifier. The method further includes resolving the first source node identifier to the second source node identifier based on the record. The method further includes sending a response to the second query, the response including the second source node identifier.

### RELATED APPLICATIONS

This application is related to the following commonly owned U.S. patent applications, the entire disclosure of each being incorporated by reference herein:

Application Ser. No. 11/962,285 (Attorney Docket No 1509/US) filed on Dec. 21, 2007, entitled “Methods And Systems For Sending Information To A Zone Included In An Internet Network”;

Application Ser. No. 12/170,281 (Attorney Docket No 1522/US) filed on Jul. 10, 2008, entitled “Methods And Systems For Resolving A Geospatial Query Region To A Network Identifier”;

Application Ser. No. 12/170,829 (Attorney Docket No 1523/US) filed on Jul. 10, 2008, entitled “Methods And Systems For Resolving Location Information To A Network Identifier”; and

Application Ser. No. 12/170,833 (Attorney Docket No 1524/US) filed on Jul. 10, 2008, entitled “Methods And Systems For Resolving A Query Region To A Network Identifier”.

### BACKGROUND

A message from a first node to a second node typically involves a Domain Name System (DNS) query by the first node to obtain the network address of the second node. This query is routed through the DNS to various DNS nodes until a DNS node that can resolve the query receives the request. The DNS includes nodes that authoritative for resolving particular queries and nodes that maintain copies of information from authoritative nodes, such as slave or caching DNS nodes that can resolve particular queries. The DNS node that is authoritative or maintains copies of records for the second node resolves the request to obtain the network address of the second node. The address is then routed back through the DNS to the first node, which can then send the message using the address of the second node.

The second node may then need to perform a query to determine an address for the first node or a reverse address lookup to determine the name or at least a domain of the sender. This is, for example, a standard security mechanism for web servers, email servers, etc. This query must be, similarly, routed through the DNS to various DNS nodes until a node that can resolve the query for the first node receives the request. The DNS node that is authoritative or maintains a copy of a relevant record for the first node resolves the request to obtain the name of the first node. The name is then routed back through the DNS to the second node, which can then send verify the identity of the first node.

Accordingly, there exists a need for methods, systems, and computer program products for resolving a first source node identifier to a second source node identifier.

### SUMMARY

Methods and systems are described for resolving a first source node identifier to a second source node identifier. In one aspect, a method for resolving a first source node identifier to a second source node identifier includes receiving, by a resolving directory service, a first query for resolving a first target node identifier to a second target node identifier in association with receiving source node information identifying a first source node identifier and a second source node identifier, the first source node identifier resolvable to the second source node identifier, the first query originating from a source node identified by the first source node identifier. The method includes storing a record associating the first source node identifier with the second source node identifier. The method further includes receiving, by the resolving directory service, a second query for resolving the first source node identifier to the second source node identifier. The method still further includes resolving the first source node identifier to the second source node identifier based on the record. The method also includes sending a response to the second query, the response including the second source node identifier.

In another aspect, a system for resolving a first source node identifier to a second source node identifier is disclosed. The system comprising system components including a target system handler component configured to receive, by a resolving directory service, a first query for resolving a first target node identifier to a second target node identifier in association with receiving source node information associating a first source node identifier with a second source node identifier, the first query originating from a source node identified by the first source node identifier. The system components further including a target record manager component configured to store a record associating the first source node identifier with the second source node identifier. The system components further including a target client handler component configured to receive, by the resolving directory service, a second query for resolving the first source node identifier to the second source node identifier. The system components further including a target domain manager component configured to resolve the first source node identifier to the second source node identifier based on the record. The system components further including the target client handler component configured to send a response to the second query, the response including the second source node identifier At least one of the system components includes at least one electronic hardware component.

In another aspect, a computer readable medium storing a computer program, executable by a machine, for resolving a first source node identifier to a second source node identifier is disclosed. The computer program comprising executable instructions for receiving, by a resolving directory service, a first query for resolving a first target node identifier to a second target node identifier in association with receiving source node information identifying a first source node identifier and a second source node identifier, the first source node identifier resolvable to the second source node identifier, the first query originating from a source node identified by the first source node identifier. The computer program comprising executable instructions for storing a record associating the first source node identifier with the second source node identifier. The computer program comprising executable instructions for receiving, by the resolving directory service, a second query for resolving the first source node identifier to the second source node identifier. The computer program comprising executable instructions for resolving the first source node identifier to the second source node identifier based on the record. The computer program comprising executable instructions for sending a response to the second query, the response including the second source node identifier.

In another aspect, a method for resolving a first source node identifier to a second source node identifier includes receiving, by a resolving directory service, a first query for resolving a first target node identifier to a second target node identifier, the first query received from a source node identified by a source node identifier. The method also includes generating a resolving request including the first target node identifier. The method further includes sending the resolving request in association with sending source node information identifying the first source node identifier and a second source node identifier, the first node identifier resolvable to the second source node identifier. The method still further includes receiving a resolving request response to the resolving request, the response including the second target node identifier. The method also includes sending a first query response to the first query to the source node, the response including the second target node identifier.

In another aspect, a system for resolving a first source node identifier to a second source node identifier. The system comprising system components including a source client handler component configured to receive, by a resolving directory service, a first query for resolving a first target node identifier to a second target node identifier, the first query received from a source node identified by a source node identifier. The system components further including a source message generator component configured to generate a resolving request including the first target node identifier. The system components further including a source system handler component configured to send the resolving request in association with sending source node information identifying the first source node identifier and a second source node identifier, the first node identifier resolvable to the second source node identifier. The source system handler component configured to receive a resolving request response to the resolving request, the response including the second target node identifier. The system components further including the source client handler component configured to send a first query response to the first query to the source node, the response including the second target node identifier. At least one of the system components includes at least one electronic hardware component.

In another aspect, a computer readable medium storing a computer program, executable by a machine, for resolving a first source node identifier to a second source node identifier is disclosed. The computer program comprising executable instructions for receiving, by a resolving directory service, a first query for resolving a first target node identifier to a second target node identifier, the first query received from a source node identified by a source node identifier. The computer program comprising executable instructions for generating a resolving request including the first target node identifier. The computer program comprising executable instructions for sending the resolving request in association with sending source node information identifying the first source node identifier and a second source node identifier, the first node identifier resolvable to the second source node identifier. The computer program comprising executable instructions for receiving a resolving request response to the resolving request, the response including the second target node identifier. The computer program comprising executable instructions for sending a first query response to the first query to the source node, the response including the second target node identifier.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIG. 2 is a message flow diagram illustrating an illustrative message flow for resolving a first source node identifier to a second source node identifier according to an aspect of the subject matter described herein;

FIG. 3 is a flow diagram illustrating a method for resolving a first source node identifier to a second source node identifier according to an aspect of the subject matter described herein;

FIG. 4 is a block diagram illustrating an arrangement of components for resolving a first source node identifier to a second source node identifier according to another aspect of the subject matter described herein;

FIG. 5 is a block diagram illustrating an arrangement of components providing an execution environment configured to host the arrangement of components of FIG. 4;

FIG. 6 is a flow diagram illustrating a method for resolving a first source node identifier to a second source node identifier according to another aspect of the subject matter described herein; and

FIG. 7 is a block diagram illustrating an arrangement of components for resolving a first source node identifier to a second source node identifier according to another aspect of the subject matter described herein.

### DETAILED DESCRIPTION

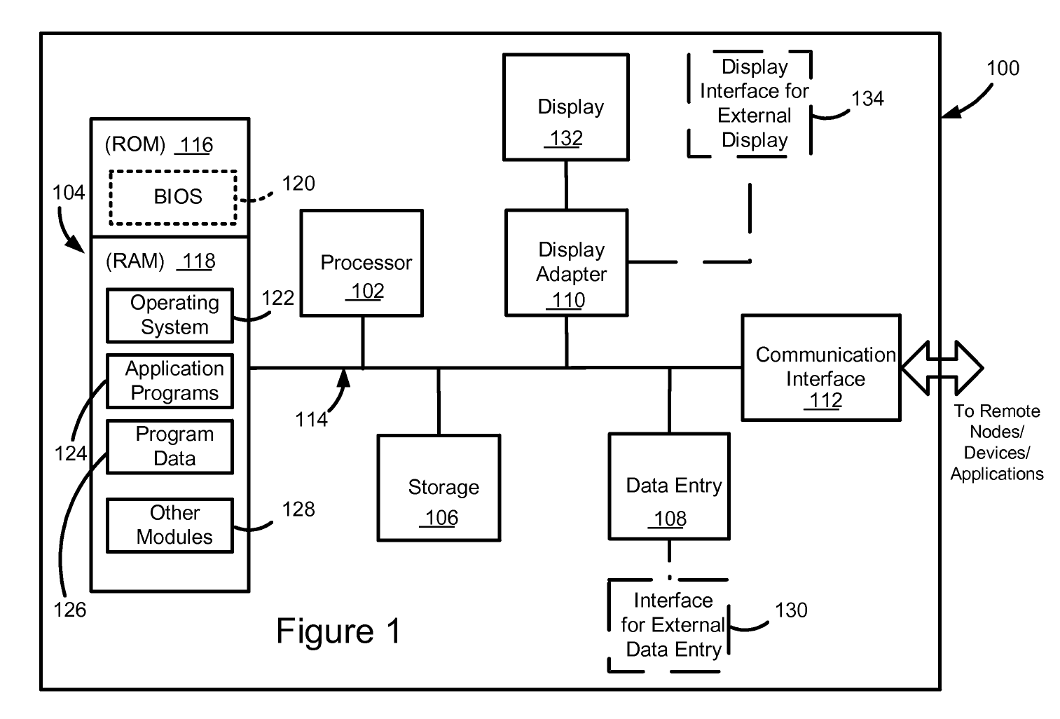

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

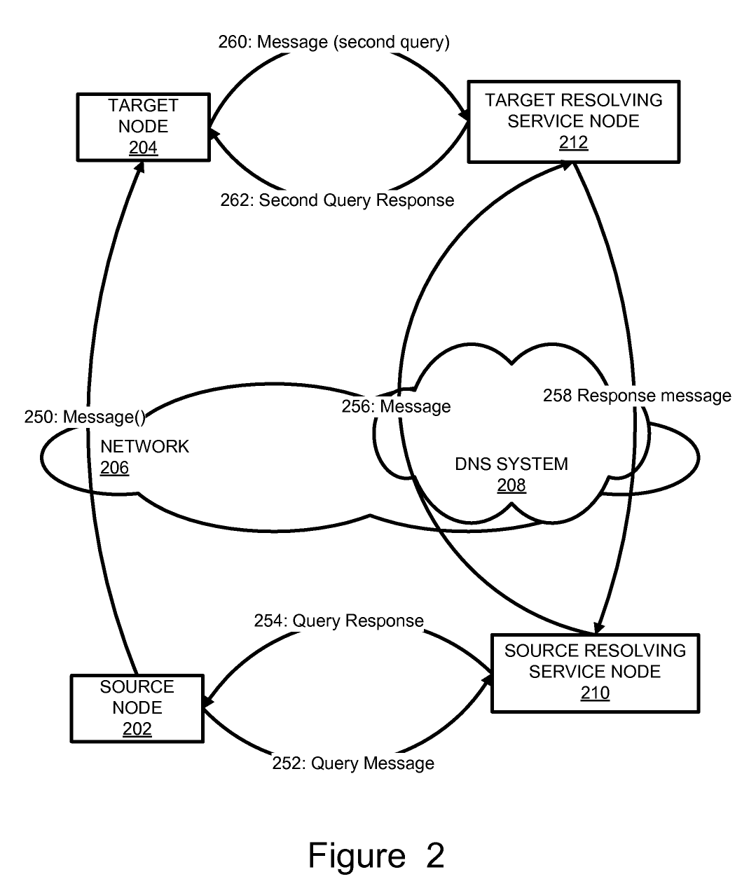

An exemplary message flow diagram illustrating various exemplary aspects associated with systems and methods for resolving a first source node identifier to a second source node identifier is illustrated in FIG. 2. According to an aspect, a source node 202 may have a need to send a message 250 to a target node 204 over a network 206. To send the message 250, the source node 202 needs an address for the target node 204. For example, the source node 202 may have a first target node identifier of the target node. The first target node identifier can be a name identifying the target node. To resolve the first target node identifier, the name, to a second target node identifier, an address, the source node would query a DNS system 208 including resolving service nodes such as a source resolving service node 210 and a target resolving service node 212 for example. For example, the source node 202 may send a query message 252 to the source resolving service node 210. The source resolving service node 210 routes the query through the DNS system 208 to determine the address of the target node and receives a response including the address of the target node. The source resolving service node 210 then sends a query response message 254 including the address of the target node to the source node 202. Upon receiving the response, the source node 202 may send the message 250 to the target node 204 over the network 206

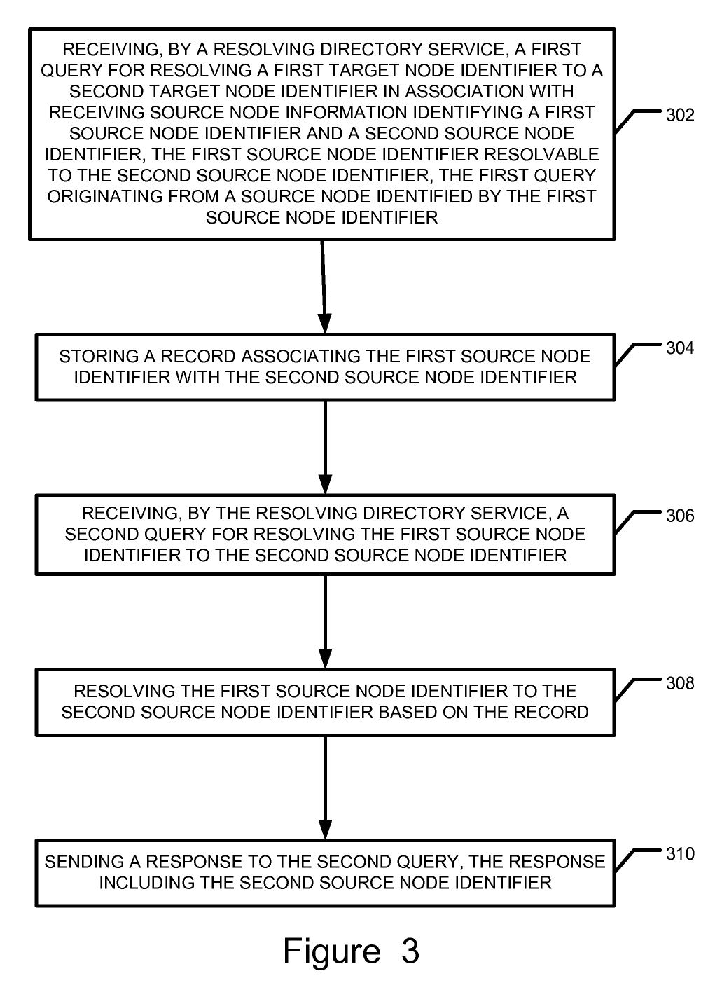

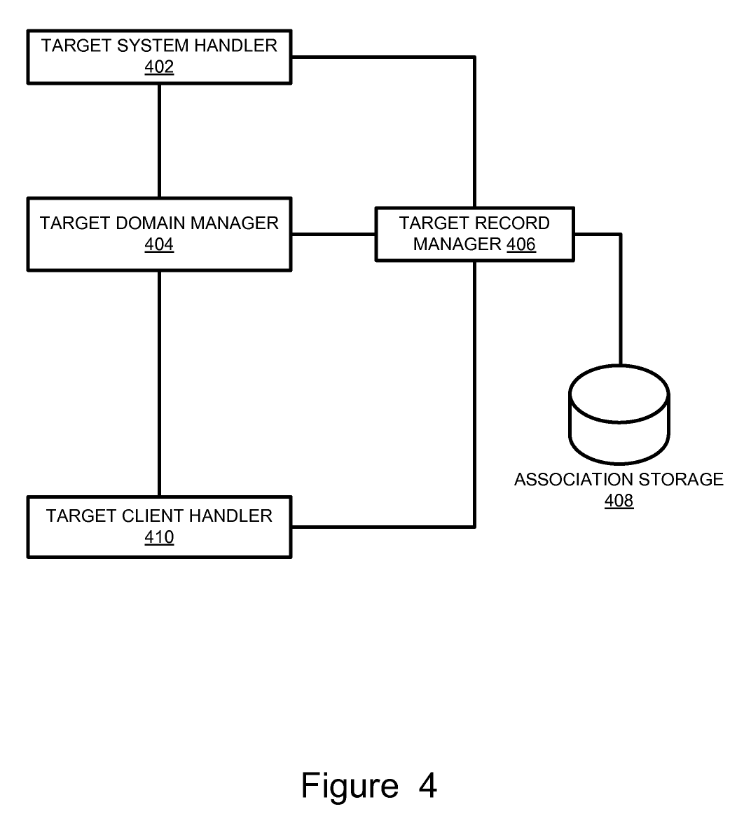

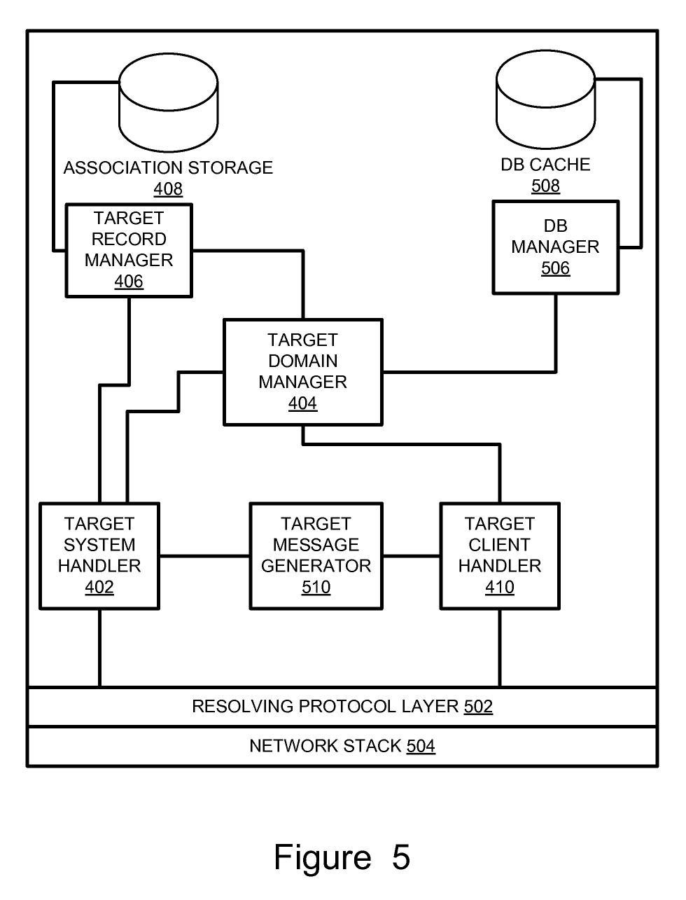

Turning now to FIG. 3, a flow diagram is illustrated illustrating a method for resolving a first source node identifier to a second source node identifier according to an exemplary aspect of the subject matter described herein. FIG. 4 is a block diagram illustrating an arrangement of components for resolving a first source node identifier to a second source node identifier according to another exemplary aspect of the subject matter described herein. FIG. 5 is a block diagram illustrating an arrangement of components providing an execution environment configured for hosting the arrangement of components depicted in FIG. 4. The method in FIG. 3 can be carried out by, for example, some or all of the components illustrated in the exemplary arrangement in FIG. 4 operating in an a compatible execution environment, such as the environment provided by some or all of the components of the arrangement in FIG. 5. The arrangement of components in FIG. 5 may be implemented by some or all of the components of the hardware device 100 of FIG. 1.

With reference to FIG. 3, in block 302 a resolving directory service receives a first query for resolving a first target node identifier to a second target node identifier in association with receiving source node information identifying a first source node identifier and a second source node identifier, the first source node identifier resolvable to the second source node identifier. The first query originated from a source node, such as the source node 202, identified by the first source node identifier. Accordingly, a system for resolving a first source node identifier to a second source node identifier includes means for receiving, by a resolving directory service, a first query for resolving a first target node identifier to a second target node identifier in association with receiving source node information identifying a first source node identifier and a second source node identifier, the first source node identifier resolvable to the second source node identifier, the first query originating from a source node identified by the first source node identifier. For example, as illustrated in FIG. 4, a target system handler component 402 is configured to receive, by a resolving directory service, a first query for resolving a first target node identifier to a second target node identifier in association with receiving source node information identifying a first source node identifier and a second source node identifier, the first source node identifier resolvable to the second source node identifier, the first query originating from a source node identified by the first source node identifier.

According to an aspect, the resolving directory service can be included in the target resolving service node 212. The target resolving service node 212 can include, the target system handler component 402. As discussed above, the target resolving service node 212 can be a DNS node or can include a plurality of DNS nodes each representing the domain. For example, two DNS nodes can each represent the domain of the target node. For example, one can be an authoritative service while the other is a slave service provided for load balancing of requests directed to the domain. Further, a DNS node can represent a parent domain of a domain of the target node with the target resolving service node 212 being the parent node representing the parent domain of the domain of the target node. The source node is not included in the target resolving service node's domain. According to an aspect, the target node is included in the target resolving service node's domain.

A DNS represents a domain space for node identifiers. A DNS can be configured to resolve a node identifier, such as a network name in a name domain space to a network address in an address domain space or vice versa in response to a request. A DNS can include one or more DNS servers operating in one or more execution environments provided by one or more nodes. Each DNS server represents one or more domains each in the domain space represented by the DNS. The DNS is responsible for a node that is included in a domain the DNS server represents or is authoritative for. For example, a DNS server can represent one or more domains in a naming domain space, an address domain space and/or a geospatial domain space.

Geospatial identifiers and domains are disclosed in application Ser. No. 12/170,281 (Attorney Docket No I522/US) filed on Jul. 10, 2008, entitled “Methods And Systems For Resolving A Geospatial Query Region To A Network Identifier”; application Ser. No. 12/170,829 (Attorney Docket No I523/US) filed on Jul. 10, 2008, entitled “Methods And Systems For Resolving Location Information To A Network Identifier”; and application Ser. No. 12/170,833 (Attorney Docket No I524/US) filed on Jul. 10, 2008, entitled “Methods And Systems For Resolving A Query Region To A Network Identifier”. A geospatial domain space can include one or more regions where each region is associated with one or more domains in the geospatial domain space. For the purposes of this specification, a region has a size that can be as large as the geospatial domain space in which it is included, or as small as can be identified. A location or region of a geospatial domain space can be associated with region information that uniquely identifies the region in the context of the geospatial domain space. Region information can include a geospatial identifier.

A node identifier can be a logical identifier for a communication endpoint on a network. For example, an Internet Protocol (IP) address is a node identifier for communicating over an IP network such as the Internet. The DNS represents a name domain space that includes a set of names that are node identifiers. The DNS is configured to map a DNS name to a network address. A node identifier can be at least one of a network address and a symbolic identifier of a network address, such as a DNS name. A network address is a network layer address identifier for a network interface (e.g. unicast) or a set of interfaces (e.g. multicast, broadcast, scoped address). For example outside scoped addresses are described in application Ser. No. 11/962,285 (Attorney Docket No I509/US) filed on Dec. 21, 2007, entitled “Methods And Systems For Sending Information To A Zone Included In An Internet Network” herein incorporated by reference.

A node identifier can be a geospatial identifier. A geospatial identifier is an identifier including at least a portion that is usable for identifying a region/location in a geospatial domain space. Examples include:
postal://usa.nc.cary.corning-road:111.suite:220.placid
postal://placid.suite:220.corning_road:111.cary.nc.usa
postal://placid.suite:220:corning_road:111.27518.
   Each of the above examples is a geospatial identifier in a geospatial domain space based on the US Post Office postal address domain space.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for addressing Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined to specify regions and locations having a variety of shapes such as a rectangle, circle, oval, or any shape including a closed region. A geospatial identifier can identify a region with disjoint sub-regions by including a geospatial attribute that identifies the sub-regions. For example, the identifier, “40+”, in an identifier domain space including average annual rainfall totals over a specified period, identifies a geospatial region including all sub-regions that have an average annual rainfall over 40 inches.

A geospatial identifier can include any of the forms and formats described above. Further a geospatial identifier can be a network identifier in the form of geospatial network address or in the form of a geospatial name correponding to at least a portion of a network address.

A node identifier can include a domain portion identifying a portion of a network and/or a node portion identifying a node having a network interface in the portion of the network identified by the domain portion. For example a network address, such as an Internet Protocol (IP) address, can include a domain portion referred to as a subnet ID. The partial IP address, 162.195.20, is an exemplary subnet ID that identifies a subnet. The nodes in the identified subnet can be identified outside the subnet by network addresses that include the IP address subnet identifier 162.195.20. To more precisely identify a subnet, an IP address or a portion of an IP address can be associated with a mask, such as 255.255.255.0. A mask identifies the subnet portion of an IP address via a logical “or” operation performed between each pair of bits identified by bit position in an IP address and the mask.

Analogously, a node identifier can be a network name identifying a node, such as a DNS name, which can include a domain portion identifying a naming domain of a network and optionally subdomains each identifying a portion of the network. For example, “nc.sceneralabs.com”, can identify a naming domain where a network interface of a node in the naming domain is associated with a name, such as, “placid”. The name “placid”, in the example, identifies the network interface of the node within the naming domain. The complete network name, “placid.nc.sceneralabs.com”, identifies the node when used outside the naming domain.

A node identifier can include a node portion that identifies a node having a network interface in a portion of the network identified by a domain portion of the node identifier. For example, in an IP address, a portion of the address is associated with a particular network interface in the identified subnet, thus identifying the network interface of the node. In the IP address 162.195.20.143 in the subnet 162.195.20.0/255.255.255.0, 143 is the node portion identifying a node having a network interface in the subnet. A subnet is a domain in the network address domain space. In a DNS name the first portion of the name identifies a node having a network interface in an identifiable domain in the DNS name domain space. As indicated, “placid” is the node portion identifying a network interface in the naming domain identified by “nc.sceneralabs.com”, and “placid.nc” is the node portion in a parent naming domain identified by the domain portion, “sceneralabs.com”.

There can be a one to one correspondence between a subnet in a network address domain and a domain in a naming domain, but a one to one correspondence is not required. For example, a domain in a naming domain space can be associated with one or more subnets or network portions. Further, a subnet can include network interfaces of nodes included in a single domain of a naming domain space or included in more than one naming domain in the domain space.

A domain space can include one or more nodes having node identifiers from the domain name space. A domain portion of a name from the domain name space, a portion of a network identified by the domain portion, a node portion of the name, and a node identified by the name can be said to be “in” and “included in” the domain space. Further, an identified portion of the network can be referred to as the domain. The node portion of the name, a network interface of the node identified by the node portion, and the node can be said to be “in” and “included in” the domain identified by the domain portion.

Analogously, a subnet portion of a network address from a domain address space, a portion of a network identified by the subnet portion, a node portion of the network address, and the node identified by the network address can be said to be “in” and “included in” the domain space. Further, an identified portion of the network can be referred to as the domain and/or subnet. The node portion of the network address, a network interface of the node identified by the node portion, and the node can be said to be “in” and “included in” the domain and/or subnet identified by the subnet portion

The first query may be received as part of a message. For example, in FIG. 2, a message 256 from the source resolving service node 210 is received by the target resolving service node 212. The message 256 can include the first query that originated from the source node 202. The message 256 can be a response to a request, a notification associated with a subscription, and/or an unsolicited asynchronous message. The message 256 can simply be the query message 252 forwarded through the DNS system 208.

Referring to FIG. 5, the message 256 can be received by the target system handler component 402 via a resolving protocol layer 502 and a network stack 504. The message 256 can be received via an application protocol layer, or other higher protocol layer, among many possible standard and proprietary protocol layers. For example, the message can be received via an application protocol layer supporting a protocol specifically for communicating with and/or within a system. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP).

According to an aspect, the source node information can be included in the first query. For example, the message 256 may include the source node information. According to another aspect the source node information can be received in another message (not shown) that is associated with the message 256.

According to an aspect, the first target node identifier can be resolved to the second target node identifier. For example, a target domain manager component 404 can be configured to resolve the first target node identifier to the second target node identifier. According to an aspect, the target domain manager component 404 can be configured to resolve the first target node identifier to the second target node identifier by performing a lookup using the first target node identifier to find the second target node identifier. For example, referring to FIG. 5, the target domain manager component 404 can call the database manager 506 to retrieve a record associating the first target node identifier and the second target node identifier in the database cache 508. As the target resolving service node 212 is responsible for the target node 204, the database cache 508 can have the record associating the first target node identifier and the second target node identifier available for retrieval. The second target node identifier is returned to the target domain manager component 404, thus resolving the first target node identifier to the second target node identifier.

If a node identifier, such as the first target node identifier, is a geospatial identifier, resolving the first target node identifier can be accomplished in any of the manners described in application Ser. No. 12/170,281 (Attorney Docket No I522/US) filed on Jul. 10, 2008, entitled “Methods And Systems For Resolving A Geospatial Query Region To A Network Identifier”; application Ser. No. 12/170,829 (Attorney Docket No I523/US) filed on Jul. 10, 2008, entitled “Methods And Systems For Resolving Location Information To A Network Identifier”; and application Ser. No. 12/170,833 (Attorney Docket No I524/US) filed on Jul. 10, 2008, entitled “Methods And Systems For Resolving A Query Region To A Network Identifier”.

After the first target node identifier is resolved to the second target node identifier, a response to the first query can be sent, the response including the second target node identifier. For example, the target system handler component 402 is configured to send a response to the first query including the second target node identifier. For example, referring to FIG. 5, a target message generator 510 can be called to generate a response including the second target node identifier. Once the message is generated by the target message generator 510, the message can be sent by the target system handler component 402 via the network stack 504. As illustrated in FIG. 2, a response message 258 can include the second target node identifier.

Returning to FIG. 3, in block 304 a record is stored associating the first source node identifier with the second source node identifier. Accordingly, a system for resolving a first source node identifier to a second source node identifier includes means for storing a record associating the first source node identifier with the second source node identifier. For example, as illustrated in FIG. 4, a target record manager component 406 is configured to store a record associating the first source node identifier with the second source node identifier.

As discussed above, the target resolving service node 212 has no information regarding the source node identifiers for the source node 202 prior to receiving the source node information. The target record manager component 406 stores a record associating the first source node identifier and the second source node identifier in, for example, an association storage 408. The record can take a variety of forms. For example, the record can include two fields, one holding the first source node identifier and the other holding the second source node identifier. In an aspect including a plurality of DNS nodes each representing the domain (as described above), the record can be stored on at least one of the plurality of DNS nodes.

According to an aspect, storing the record can be performed automatically for all queries based on a configuration of the resolving directory service. For example, target record manager component 406 is configured to store the record automatically for all queries based on a configuration of the resolving directory service. In another aspect, storing the record includes determining that the first query is associated with the source node information. For example, the target record manager component 406 is configured to determine that the first query is associated with the source node information. The determination can be based on information received from the target system handler component 402 or the target domain manager component 404. Upon making the determination, the target record manager component 406 would then store the record.

In another aspect, storing the record includes determining that the first node identifier included in a domain that the resolving directory service is configured to store records for. For example, the target record manager component 406 is configured to determine that the first node identifier included in a domain that the resolving directory service is configured to store records for.

Returning to FIG. 3, in block 306 the resolving directory service receives a second query for resolving the first source node identifier to the second source node identifier. Accordingly, a system for resolving a first source node identifier to a second source node identifier includes means for receiving, by the resolving directory service, a second query for resolving the first source node identifier to the second source node identifier. For example, as illustrated in FIG. 4, a target client handler component 410 is configured to receive, by the resolving directory service, a second query for resolving the first source node identifier to the second source node identifier.

Referring again to FIG. 2, the target node 204, upon receiving the message 250 from the source node 202, may want to verify that the identity of the sender of the message 250. The target node 204 may query the DNS System 208 to perform a reverse lookup. For example, the target node 204 may know a first source node identifier, the address of the source node 202, and may want to resolve the first source node identifier to a second source node identifier, the name of the source node 202. This would verify the identity of the source node 202 that sent the message 250. Accordingly, the target node would send a message 260 (including the second query) to the target resolving service node 212.

The first query may be received as part of a message. For example, in FIG. 2, a message 260 from the target node 204 is received by the target resolving service node 212. The message 260 can include the second query. The message 260 can be a response to a request, a notification associated with a subscription, and/or an unsolicited asynchronous message.

Referring to FIG. 5, the message 260 can be received by the target client handler component 410 via a resolving protocol layer 502 and a network stack 504. The message 260 can be received via an application protocol layer, or other higher protocol layer, among many possible standard and proprietary protocol layers. For example, the message can be received via an application protocol layer supporting a protocol specifically for communicating with and/or within a system. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP).

Returning to FIG. 3, in block 308 the first source node identifier is resolved to the second source node identifier based on the record. Accordingly, a system for resolving a first source node identifier to a second source node identifier includes means for resolving the first source node identifier to the second source node identifier based on the record. For example, as illustrated in FIG. 4, a target domain manager component 404 is configured to resolving the first source node identifier to the second source node identifier based on the record.

According to an aspect, in order to resolve the first node identifier to the second node identifier, the resolving directory service needs to determine whether it is responsible for the source node identified by the first source node identifier. For example, the resolving directory service can determine whether it represents or is authoritative for the domain/subnet/geo-region of the source node identifier in the second query. Accordingly, it can be determined that the resolving directory service is not responsible for the source node identified by the first source node identifier. For example, the target domain manager component 404 can be configured to determine that the resolving directory service is not responsible for the source node identified by the first source node identifier. In response to the determination, the first source node identifier is resolved to the second source node identifier based on the record.

For example, the target domain manager component 404 can, upon making the determination, request that the target record manager component 406 perform a lookup for the record including the first source node identifier in the association storage 408. The record will include, as described above, the second node identifier. The target record manager component 406 can return the second node identifier to the target domain manager component 404, thus resolving the first source node identifier to the second source node identifier based on the record. In an aspect including a plurality of DNS nodes each representing the domain (as described above), at least one of the plurality of nodes can receive the query, and resolve the query by forwarding the query to the node having the record for resolution. In an aspect including a plurality of DNS nodes each representing the domain (as described above), at least one of the plurality of nodes can receive the query, and resolve the query by requesting the source node information from the node having the record, and then resolving the query based on the source node information.

Returning to FIG. 3, in block 310 a response to the second query is sent. The response includes the second source node identifier. Accordingly, a system for resolving a first source node identifier to a second source node identifier includes means for sending a response to the second query, the response including the second source node identifier. For example, as illustrated in FIG. 4, a target client handler component 410 is configured to send a response to the second query, the response including the second source node identifier.

After the first source node identifier is resolved to the second source node identifier, a response to the second query can be sent, the response including the second source node identifier. The target client handler component 410 receives the second source node identifier from the target domain manager component 404 or the target record manager component 406. According to an aspect illustrated in FIG. 5, the target client handler component 410 can call the target message generator 510 to generate a response including the second source node identifier. Once the message is generated by the target message generator 510, the message can be sent by the target client handler component 410 via the network stack 504.

For example, returning to FIG. 2, the target resolving service node 212 can send a second query response 262 to the target node 204. The second query response 262 can include the second source node identifier. For example, the second source node identifier can be a name that identifies the source node 202. The name verifies the source node 202 as the sender of the message 250.

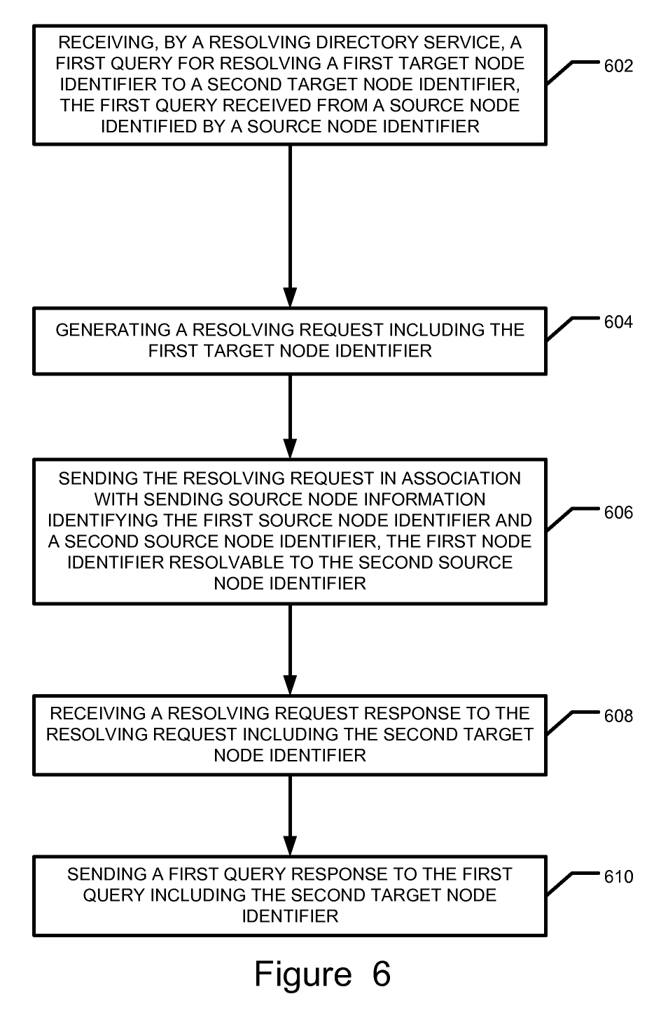

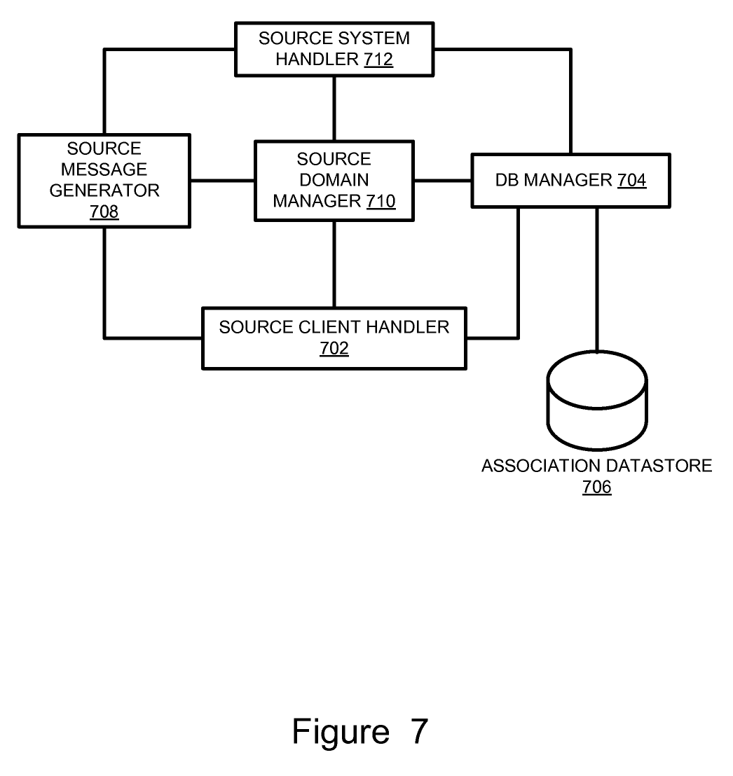

Turning now to FIG. 6, a flow diagram is illustrated illustrating a method for resolving a first source node identifier to a second source node identifier according to an exemplary aspect of the subject matter described herein. FIG. 7 is a block diagram illustrating a system for resolving a first source node identifier to a second source node identifier according to another exemplary aspect of the subject matter described herein. The execution environment illustrated in FIG. 5 can be configured for hosting the arrangement of components depicted in FIG. 7. The method in FIG. 6 can be carried out by, for example, some or all of the components illustrated in the exemplary arrangement in FIG. 7 operating in an a compatible execution environment, such as the environment provided by some or all of the components of the arrangement in FIG. 5.

As stated above with reference to FIG. 2, according to an aspect, the source node 202 may want to send the message 250 to the target node 204 over the network 206. To send the message 250, the source node 202 needs an address for the target node 204. For example, the source node 202 may have a first target node identifier of the target node. The first target node identifier can be a name identifying the target node. To resolve the first target node identifier, the name, to a second target node identifier, an address, the source node would query the DNS system 208 including resolving service nodes such as the source resolving service node 210 and a target resolving service node 212 for example. For example, the source node 202 may send a query message 252 to the source resolving service node 210.

With reference to FIG. 6, in block 602 a resolving directory service receives a first query for resolving a first target node identifier to a second target node identifier, the first query received from a source node identified by a source node identifier. Accordingly, a system for resolving a first source node identifier to a second source node identifier includes means for receiving, by a resolving directory service, a first query for resolving a first target node identifier to a second target node identifier, the first query received from a source node identified by a source node identifier. For example, as illustrated in FIG. 7, a source client handler component 702 is configured to receive, by a resolving directory service, a first query for resolving a first target node identifier to a second target node identifier, the first query received from a source node identified by a source node identifier.

The first query may be received as part of a message. For example, in FIG. 2, the query message 252 from the source node 202 is received by the source resolving service node 210. The query message 252 can include the first query from the source node 202. The query message 252 can be a response to a request, a notification associated with a subscription, and/or an unsolicited asynchronous message.

The query message 252 can be received by the source client handler component 402 via a protocol layer, such as the resolving protocol layer 502 illustrated in FIG. 5 and a network stack, such as the network stack 504 illustrated in FIG. 5. The query message 252 can be received via an application protocol layer, or other higher protocol layer, among many possible standard and proprietary protocol layers. For example, the message can be received via an application protocol layer supporting a protocol specifically for communicating with and/or within a system. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP).

Further, the resolving directory service can maintain a record associating the first source node identifier with the second source node identifier. If the source resolving service node 210 is responsible for the source node 202 it will maintain such a record. For example, if he source resolving service node 210 is authoritative for a domain including the source node identifier, it will maintain such a record. For example, a source database manager component 704 can be configured to maintain, by the resolving directory service, a record associating the first source node identifier with the second source node identifier. For example, the source database manager component 704 can be configured to store the record associating the first source node identifier with the second source node identifier in an association data store 706. As described above, a record associating the first source node identifier with the second source node identifier can include, for example, two fields, one including the first source node identifier and the other including the second source node identifier.

Returning to FIG. 6, in block 604 a resolving request including the first target node identifier is generated. Accordingly, a system for resolving a first source node identifier to a second source node identifier includes means for generating a resolving request including the first target node identifier. For example, as illustrated in FIG. 7, a source message generator component 708 is configured to generating a resolving request including the first target node identifier.

The source resolving service node 210 can determine that it is unable to resolve the first target node identifier, thus it must forward the request through the DNS system 208. For example, a source domain manager 710 can determine that the first target node identifier is not in its cache or in the association data store 706. The source domain manager 710 can determine that the target node identifier is not in its domain.

In response to this determination, the source resolving service node 210 must forward the request through the DNS system 208. Accordingly, the source message generator component 708 is called to generate a resolving request including the first target node identifier. The resolving request can simply be the first query received in the query message 252 forwarded through the DNS system 208.

Returning to FIG. 6, in block 606 the resolving request is sent in association with sending source node information identifying the first source node identifier and a second source node identifier, the first node identifier resolvable to the second source node identifier. Accordingly, a system for resolving a first source node identifier to a second source node identifier includes means for sending the resolving request in association with sending source node information identifying the first source node identifier and a second source node identifier, the first node identifier resolvable to the second source node identifier. For example, as illustrated in FIG. 7, a source system handler component 712 is configured to send the resolving request in association with sending source node information identifying the first source node identifier and a second source node identifier, the first node identifier resolvable to the second source node identifier.

According to an aspect, the source system handler component 712 can be configured to send source node information in the message 256 including the resolving request or in a separate message (not shown). The source system handler component 712 can be configured to automatically send the source node information with all resolving requests forwarded through the DNS system 208. According to another aspect, the first query can include a request to send the source node information in association with the resolving request. For example, the source client handler component 702 can be configured to receive the first query including a request to send the source node information in association with the resolving request.

In another aspect, the resolving directory service is configured to send the source node information in association with the resolving request based on a domain of at least one of the first source node identifier, the second source node identifier, the first target node identifier, and the second target node identifier. For example, the source system handler component 712 can be configured to send the source node information in association with the resolving request based on a domain of at least one of the first source node identifier, the second source node identifier, the first target node identifier, and the second target node identifier.

In another aspect, the resolving directory service is configured to send the source node information in association with the resolving request based on an application type associated with the first query. For example, the source system handler component 712 can be configured to send the source node information in association with the resolving request based on an application type associated with the first query.

In another aspect, the resolving directory service is configured to send the source node information in association with the resolving request based on a port number associated with the request. For example, the source system handler component 712 can be configured to send the source node information in association with the resolving request based on a port number associated with the request.

Returning to FIG. 6, in block 608 a resolving request response to the resolving request is received. The response includes the second target node identifier. Accordingly, a system for resolving a first source node identifier to a second source node identifier includes means for receiving a resolving request response to the resolving request, the response including the second target node identifier. For example, as illustrated in FIG. 7, the source system handler component 712 is configured to receive a resolving request response to the resolving request, the response including the second target node identifier.

The resolving request is, as described above with reference to FIG. 2, routed through the DNS system 208. The target resolving service node 212 receives the resolving request in, for example, the message 256. In response to receiving the request, the target resolving service node 212 resolves the first target node identifier to the second target node identifier as described above. The target resolving service node 212 then sends the response message 258 including the second target node identifier to the source resolving service node 210. The source system handler component 712 receives the response including the second target node identifier.

Returning to FIG. 6, in block 610 a first query response to the first query is sent to the source node, the response including the second target node identifier. Accordingly, a system for resolving a first source node identifier to a second source node identifier includes means for sending a first query response to the first query to the source node, the response including the second target node identifier. For example, as illustrated in FIG. 7, the source client handler component 702 is configured to send a first query response to the first query to the source node, the response including the second target node identifier.

After the response including the second target node identifier is received, a response to the first query can be sent, the response including the second target node identifier. The source domain manager component 710, or any other component, can call the source message generator 708 to generate a first query response including the second target node identifier. Once the first query response is generated by the source message generator 708, the first query response can be sent by the source client handler component 702.

Returning to FIG. 2, the source resolving service node 210 can send a first query response message 254 to the source node 202. The first query response message can include the second target node identifier. For example, the second target node identifier can be an address for the target node 204. The address allows the source node 202 to send the message 250 to the target node 204.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for resolving a first source node identifier to a second source node identifier, the method comprising:
receiving, by a resolving directory service, a first query for resolving a first target node identifier to a second target node identifier in association with receiving source node information associating a first source node identifier with a second source node identifier, the first query originating from a source node identified by the first source node identifier;
storing a record associating the first source node identifier with the second source node identifier;
receiving, by the resolving directory service, a second query for resolving the first source node identifier to the second source node identifier;
resolving the first source node identifier to the second source node identifier based on the record; and
sending a response to the second query, the response including the second source node identifier,
wherein at least one of the preceding actions is performed on at least one electronic hardware component.

2. The method of claim 1 wherein the source node information is included in the first query.

3. The method of claim 1 wherein storing the record is performed automatically for all queries based on a configuration of the resolving directory service.

4. The method of claim 1 wherein storing the record includes determining that the first query is associated with the source node information.

5. The method of claim 1 wherein storing the record includes determining that the first node identifier included in a domain that the resolving directory service is configured to store records for.

6. The method of claim 1 further comprising determining that the resolving directory service is not responsible for the source node identified by the first source node identifier, and wherein resolving the first source node identifier to the second source node identifier based on the record is in response to the determination

7. The method of claim 1 further comprising:
resolving the first target node identifier to the second target node identifier; and
sending a response to the first query including the second target node identifier.

8. The method of claim 1 wherein the first target node identifier is a name, the second target node identifier is an address, the first source node identifier is an address, and the second source node identifier is a name.

9. The method of claim 1 wherein at least one of the first target node identifier, the second target node identifier, the first source node, and the second source node identifier is a geospatial identifier.

10. A method for resolving a first source node identifier to a second source node identifier, the method comprising:
receiving, by a resolving directory service, a first query for resolving a first target node identifier to a second target node identifier, the first query received from a source node identified by a source node identifier;
generating a resolving request including the first target node identifier;
sending the resolving request in association with sending source node information identifying the first source node identifier and a second source node identifier, the first node identifier resolvable to the second source node identifier;
receiving a resolving request response to the resolving request, the response including the second target node identifier; and
sending a first query response to the first query to the source node, the response including the second target node identifier,
wherein at least one of the preceding actions is performed on at least one electronic hardware component.

11. The method of claim 10 further comprising maintaining, by the resolving directory service, a record associating the first source node identifier with the second source node identifier.

12. The method of claim 10 further comprising determining that the resolving directory service is not responsible for a target node identified by the first target node identifier, and wherein generating the resolving request is in response to the determination.

13. The method of claim 10 wherein the first query includes a request to send the source node information in association with the resolving request.

14. The method of claim 10 wherein the resolving directory service is configured to send the source node information in association with the resolving request based on a domain of at least one of the first source node identifier, the second source node identifier, the first target node identifier, and the second target node identifier.

15. The method of claim 10 wherein the resolving directory service is configured to send the source node information in association with the resolving request based on an application type associated with the first query.

16. The method of claim 10 wherein the resolving directory service is configured to send the source node information in association with the resolving request based on a port number associated with the request.

17. The method of claim 10 wherein the first target node identifier is a name, the second target node identifier is an address, the first source node identifier is an address, and the second source node identifier is a name.

18. The method of claim 10 wherein at least one of the first target node identifier, the second target node identifier, the first source node, and the second source node identifier is a geospatial identifier.

19. A system for resolving a first source node identifier to a second source node identifier, the system comprising:
means for receiving, by a resolving directory service, a first query for resolving a first target node identifier to a second target node identifier in association with receiving source node information associating a first source node identifier with a second source node identifier, the first query originating from a source node identified by the first source node identifier;
means for storing a record associating the first source node identifier with the second source node identifier;
means for receiving, by the resolving directory service, a second query for resolving the first source node identifier to the second source node identifier;
means for resolving the first source node identifier to the second source node identifier based on the record; and
means for sending a response to the second query, the response including the second source node identifier,
wherein at least one of the means includes at least one electronic hardware component.

20. A system for resolving a first source node identifier to a second source node identifier, the system comprising system components including:
a target system handler component configured to receive, by a resolving directory service, a first query for resolving a first target node identifier to a second target node identifier in association with receiving source node information associating a first source node identifier with a second source node identifier, the first query originating from a source node identified by the first source node identifier;
a target record manager component configured to store a record associating the first source node identifier with the second source node identifier;
a target client handler component configured to receive, by the resolving directory service, a second query for resolving the first source node identifier to the second source node identifier;
a target domain manager component configured to resolve the first source node identifier to the second source node identifier based on the record; and
the target client handler component configured to send a response to the second query, the response including the second source node identifier,
wherein at least one of the system components includes at least one electronic hardware component.

21. The system of claim 20 wherein the target system handler component is configured to receive the source node information included in the first query.

22. The system of claim 20 wherein the target record manager component is configured to store the record automatically for all queries based on a configuration of the resolving directory service.

23. The system of claim 20 wherein the target record manager component is configured to determine that the first query is associated with the source node information.

24. The system of claim 20 wherein the target record manager component is configured to determine that the first node identifier is included in a domain that the resolving directory service is configured to store records for.

25. The system of claim 20 wherein the target domain manager component is configured to determine that the resolving directory service is not responsible for the source node identified by the first source node identifier.

26. The system of claim 20 wherein the target domain manager component is configured to resolve the first target node identifier to the second target node identifier; and the target system handler component is configured to send a response to the first query including the second target node identifier.

27. The system of claim 20 wherein the first target node identifier is a name, the second target node identifier is an address, the first source node identifier is an address, and the second source node identifier is a name.

28. The system of claim 20 wherein at least one of the first target node identifier, the second target node identifier, the first source node, and the second source node identifier is a geospatial identifier.

29. A system for resolving a first source node identifier to a second source node identifier, the system comprising:
means for receiving, by a resolving directory service, a first query for resolving a first target node identifier to a second target node identifier, the first query received from a source node identified by a source node identifier;
means for generating a resolving request including the first target node identifier;
means for sending the resolving request in association with sending source node information identifying the first source node identifier and a second source node identifier, the first node identifier resolvable to the second source node identifier;
means for receiving a resolving request response to the resolving request, the response including the second target node identifier; and
means for sending a first query response to the first query to the source node, the response including the second target node identifier,
wherein at least one of the means includes at least one electronic hardware component.

30. A system for resolving a first source node identifier to a second source node identifier, the system comprising system components including:
a source client handler component configured to receive, by a resolving directory service, a first query for resolving a first target node identifier to a second target node identifier, the first query received from a source node identified by a source node identifier;
a source message generator component configured to generate a resolving request including the first target node identifier;
a source system handler component configured to send the resolving request in association with sending source node information identifying the first source node identifier and a second source node identifier, the first node identifier resolvable to the second source node identifier;
the source system handler component configured to receive a resolving request response to the resolving request, the response including the second target node identifier; and
the source client handler component configured to send a first query response to the first query to the source node, the response including the second target node identifier,
wherein at least one of the system components includes at least one electronic hardware component.

31. The system of claim 30 further comprising a source database manager component configured to maintain, by the resolving directory service, a record associating the first source node identifier with the second source node identifier.

32. The system of claim 30 further comprising a source domain manager component configured to determine that the resolving directory service is not responsible for a target node identified by the first target node identifier, and wherein the source message generator component is configured to generate the resolving request is in response to the determination.

33. The system of claim 30 wherein the source client handler component is configured to receive the first query including a request to send the source node information in association with the resolving request.

34. The system of claim 30 wherein the source system handler component is configured to send the source node information in association with the resolving request based on a domain of at least one of the first source node identifier, the second source node identifier, the first target node identifier, and the second target node identifier.

35. The system of claim 30 wherein the source system handler component is configured to send the source node information in association with the resolving request based on an application type associated with the first query.

36. The system of claim 30 wherein the source system handler component is configured to send the source node information in association with the resolving request based on a port number associated with the request.

37. The system of claim 30 wherein the first target node identifier is a name, the second target node identifier is an address, the first source node identifier is an address, and the second source node identifier is a name.

38. A computer readable medium storing a computer program, executable by a machine, for resolving a first source node identifier to a second source node identifier, the computer program comprising executable instructions for:
receiving, by a resolving directory service, a first query for resolving a first target node identifier to a second target node identifier in association with receiving source node information identifying a first source node identifier and a second source node identifier, the first source node identifier resolvable to the second source node identifier, the first query originating from a source node identified by the first source node identifier;
storing a record associating the first source node identifier with the second source node identifier;
receiving, by the resolving directory service, a second query for resolving the first source node identifier to the second source node identifier;
resolving the first source node identifier to the second source node identifier based on the record; and
sending a response to the second query, the response including the second source node identifier.

39. A computer readable medium storing a computer program, executable by a machine, for resolving a first source node identifier to a second source node identifier, the computer program comprising executable instructions for:
receiving, by a resolving directory service, a first query for resolving a first target node identifier to a second target node identifier, the first query received from a source node identified by a source node identifier;
generating a resolving request including the first target node identifier;
sending the resolving request in association with sending source node information identifying the first source node identifier and a second source node identifier, the first node identifier resolvable to the second source node identifier;
receiving a resolving request response to the resolving request, the response including the second target node identifier; and
sending a first query response to the first query to the source node, the response including the second target node identifier.
